(19) United States
(12) Patent Application Publication
(10) Pub. No.: US 2013/0085731 A1
(43) Pub. Date: Apr. 4, 2013

(54) METHODS AND SYSTEMS FOR MULTIPLE-DOMAIN INVERSION OF COLLECTED DATA

(71) Applicants: Michele De Stefano, Soncino (CR) (IT); Simone Re, Fara Novarese (NO) (IT); Federico Miorelli, Cinisello Balsamo - MI (IT); Federico Golfre' Andreasi, San Donato Milanese (MI) (IT)

(72) Inventors: Michele De Stefano, Soncino (CR) (IT); Simone Re, Fara Novarese (NO) (IT); Federico Miorelli, Cinisello Balsamo - MI (IT); Federico Golfre' Andreasi, San Donato Milanese (MI) (IT)

(21) Appl. No.: 13/252,362

(22) Filed: Oct. 4, 2011

(51) Int. Cl. G06G 7/48

(52) U.S. Cl. 703/6

(57) ABSTRACT

Methods and computing systems for multiple-domain inversion are disclosed to enhance subsurface region evaluation. In one embodiment, three or more datasets corresponding to a subterranean region are received, wherein at least one of the datasets is a magnetic dataset; and the three or more datasets are jointly inverted to generate at least a velocity model that corresponds to at least a first part of the subterranean region, and a susceptibility model that corresponds to at least the first part of the subterranean region, wherein the velocity model and the susceptibility model are correlated.

### TECHNICAL FIELD

The disclosed embodiments relate generally to data analysis, and more particularly, to computing systems and methods for multiple-domain inversion of data that corresponds to a subsurface region.

### BACKGROUND

Field methods relating to magnetic datasets were among the first techniques used for geophysical exploration. Ground magnetometers, even if very slow and cumbersome, were commonly used in 1920s and 1930s. A 1926 oil discovery in Garza Country, Texas, was the result of the interpretation of a magnetic survey (Gibson and Millegan, 1998). In the past century, several improvements were made in the development of magnetometers that were, each time, more precise and easy to use. For example, Victor Vacquier's airborne fluxgate magnetometer was extremely valuable in exploration, and it was also widely used throughout World War II for submarine detection; other examples over the last century included the proton-precession magnetometer in 1955, and the optically pumped alkali-vapor magnetometers of the 1960's.

In recent years, gravity and magnetic methods have acquired a new value in the field of data measurement integration, particularly in joint inversion applications, such as Simultaneous Joint Inversion (“SJI”). For example, seismic and gravity data can improve salt base, thrust belt, and sub-basalt imaging.

As a consequence of the Green's third identity, however, magnetic inversions have traditionally suffered a high degree of non-uniqueness (Blakely, 1996). Nevertheless, geophysically interesting results can be achieved by incorporating magnetic data in some circumstances. Towards this end, SJI techniques can be used to incorporate magnetic datasets in multiple-domain inversions to improve imaging where no coverage or illumination is provided by other data sources, e.g. where seismic data does not provide coverage or illumination.

Accordingly, there is a need for methods and systems that can employ more effective and accurate methods for inversion, including magnetic inversion. Such methods and systems may complement or replace conventional methods and systems for inversion.

### SUMMARY

The above deficiencies and other problems associated with inversion are reduced or eliminated by the disclosed methods and computing systems.

In accordance with some embodiments, a method is performed that includes: receiving a magnetic dataset that corresponds to a subterranean region; receiving a second domain dataset that corresponds to the subterranean region; and jointly inverting the magnetic dataset and the second domain dataset to generate a second domain output model, wherein the second domain output model corresponds to at least a part of the subterranean region, and the joint inversion of the magnetic dataset and the second dataset is based at least in part on a cross-gradients constraint.

In accordance with some embodiments, a computing system is provided that includes at least one processor, at least one memory, and one or more programs stored in the at least one memory, wherein the one or more programs are configured to be executed by the one or more processors, the one or more programs including instructions for receiving a magnetic dataset that corresponds to a subterranean region; receiving a second domain dataset that corresponds to the subterranean region; and jointly inverting the magnetic dataset and the second domain dataset to generate a second domain output model, wherein the second domain output model corresponds to at least a part of the subterranean region, and the joint inversion of the magnetic dataset and the second dataset is based at least in part on a cross-gradients constraint.

In accordance with some embodiments, a computer readable storage medium having a set of one or more programs including instructions that when executed by a computing system cause the computing system to: receive a magnetic dataset that corresponds to a subterranean region; receive a second domain dataset that corresponds to the subterranean region; and jointly invert the magnetic dataset and the second domain dataset to generate a second domain output model, wherein the second domain output model corresponds to at least a part of the subterranean region, and the joint inversion of the magnetic dataset and the second dataset is based at least in part on a cross-gradients constraint.

In accordance with some embodiments, a system includes at least one processor, at least one memory, and one or more programs stored in the at least one memory; and means for receiving a magnetic dataset that corresponds to a subterranean region; means for receiving a second domain dataset that corresponds to the subterranean region; and means for jointly inverting the magnetic dataset and the second domain dataset to generate a second domain output model, wherein the second domain output model corresponds to at least a part of the subterranean region, and the joint inversion of the magnetic dataset and the second dataset is based at least in part on a cross-gradients constraint.

In accordance with some embodiments, an information processing apparatus for use in a computing system includes means for receiving a magnetic dataset that corresponds to a subterranean region; means for receiving a second domain dataset that corresponds to the subterranean region; and means for jointly inverting the magnetic dataset and the second domain dataset to generate a second domain output model, wherein the second domain output model corresponds to at least a part of the subterranean region, and the joint inversion of the magnetic dataset and the second dataset is based at least in part on a cross-gradients constraint.

In some embodiments, an aspect of the invention involves generating a magnetic susceptibility model that corresponds to at least the part of the subterranean region.

In some embodiments, an aspect of the invention includes that the magnetic susceptibility model is generated at least in part by back-converting one or more scalar magnetization values.

In some embodiments, an aspect of the invention involves preprocessing the magnetic dataset for inversion.

In some embodiments, an aspect of the invention includes that the second domain output model is correlated to the magnetic susceptibility model.

In some embodiments, an aspect of the invention includes that the inversion of the magnetic dataset is based at least in part on a positivity constraint.

In some embodiments, an aspect of the invention includes that the joint inversion of the magnetic dataset and the second dataset is based at least in part on a non-linear conjugate gradients algorithm.

In some embodiments, an aspect of the invention includes that the second dataset comprises a datatype selected from the group consisting of refraction tomography data, reflection tomography data, gravity data, gradiometry data, magnetotelluric data, Controlled Source electromagnetic (CSEM) data, Time Domain electromagnetic data (TDEM), surface wave data, and DC resistivity data.

In some embodiments, an aspect of the invention includes jointly inverting a third dataset with the magnetic dataset and the second dataset.

In accordance with some embodiments, a method is performed that includes: receiving three or more datasets corresponding to a subterranean region, wherein at least one of the datasets is a magnetic dataset; and jointly inverting the three or more datasets to generate at least: a first domain output model that corresponds to at least a first part of the subterranean region, and a susceptibility model that corresponds to at least the first part of the subterranean region, wherein the first domain output model is correlated to the susceptibility model.

In accordance with some embodiments, a computing system is provided that includes at least one processor, at least one memory, and one or more programs stored in the at least one memory, wherein the one or more programs are configured to be executed by the one or more processors, the one or more programs including instructions for receiving three or more datasets corresponding to a subterranean region, wherein at least one of the datasets is a magnetic dataset; and jointly inverting the three or more datasets to generate at least: a first domain output model that corresponds to at least a first part of the subterranean region, and a susceptibility model that corresponds to at least the first part of the subterranean region, wherein the first domain output model is correlated to the susceptibility model.

In accordance with some embodiments, a computer readable storage medium having a set of one or more programs including instructions that when executed by a computing system cause the computing system to: receive three or more datasets corresponding to a subterranean region, wherein at least one of the datasets is a magnetic dataset; and jointly invert the three or more datasets to generate at least: a first domain output model that corresponds to at least a first part of the subterranean region, and a susceptibility model that corresponds to at least the first part of the subterranean region, wherein the first domain output model is correlated to the susceptibility model.

In accordance with some embodiments, a system includes at least one processor, at least one memory, and one or more programs stored in the at least one memory; and means for receiving three or more datasets corresponding to a subterranean region, wherein at least one of the datasets is a magnetic dataset; and means for jointly inverting the three or more datasets to generate at least: a first domain output model that corresponds to at least a first part of the subterranean region, and a susceptibility model that corresponds to at least the first part of the subterranean region, wherein the first domain output model is correlated to the susceptibility model.

In accordance with some embodiments, an information processing apparatus for use in a computing system includes means for receiving three or more datasets corresponding to a subterranean region, wherein at least one of the datasets is a magnetic dataset; and means for jointly inverting the three or more datasets to generate at least: a first domain output model that corresponds to at least a first part of the subterranean region, and a susceptibility model that corresponds to at least the first part of the subterranean region, wherein the first domain output model is correlated to the susceptibility model.

In some embodiments, an aspect of the invention includes that the correlation of the first domain output model to the susceptibility model is based at least in part on one or more effects of a link function.

In some embodiments, an aspect of the invention includes that the inversion of the magnetic dataset is based at least in part on use of a positivity constraint.

In some embodiments, an aspect of the invention includes that the inversion of the magnetic dataset is based at least in part on use of a non-linear algorithm.

In some embodiments, an aspect of the invention includes that the joint inversion of the datasets is based at least in part on a cross-gradients constraint.

In some embodiments, an aspect of the invention includes that at least one of the datasets corresponding to the subterranean region comprises a datatype selected from the group consisting of refraction tomography data, reflection tomography data, gravity data, gradiometry data, magnetotelluric data, Controlled Source electromagnetic (CSEM) data, Time Domain electromagnetic data (TDEM), surface wave data and DC resistivity data.

In some embodiments, an aspect of the invention involves generating a cross domain dataset during the joint inversion.

In some embodiments, an aspect of the invention involves generating one or more images of at least a first part of the subterranean region, wherein the generation of the one or more images is based at least in part on the first domain output model and the susceptibility model.

In some embodiments, an aspect of the invention includes that the joint inversion includes generating a cross domain dataset and that the generation of the one or more images is based at least in part on the cross domain dataset.

Thus, the systems and methods disclosed herein are more efficient and/or effective methods for inversion. These systems and methods increase inversion effectiveness and accuracy. Such methods and interfaces may complement or replace conventional methods for inversion.

### BRIEF DESCRIPTION OF THE DRAWINGS

For a better understanding of the aforementioned embodiments as well as additional embodiments thereof, reference should be made to the Description of Embodiments below, in conjunction with the following drawings in which like reference numerals refer to corresponding parts throughout the figures.

FIG. 1A illustrates a computing system in accordance with some embodiments.

FIG. 1B illustrates a logical framework for joint inversion according to some embodiments.

FIG. 1C illustrates a workflow 150 for joint inversion according to some embodiments.

FIG. 2 illustrates streamlines for a magnetic field generated by a right rectangular prism in accordance with some embodiments.

FIGS. 3A and 3B illustrate a cross section and plan section, respectively, of a susceptibility model including a buried cube.

FIGS. 4A and 4B illustrate magnetic anomalies caused by the buried cube 301 of FIG. 3.

FIG. 5 illustrates an example comparison of magnetic effects.

FIG. 6 illustrates a double-limiting quasi-linear function in accordance with some embodiments.

FIGS. 7A and 7B illustrate a velocity model cross section and plan section, respectively, in accordance with some embodiments.

FIG. 8 illustrates a susceptibility model in accordance with some embodiments.

FIG. 9A illustrates a layout of seismic sources and receivers in accordance with some embodiments.

FIG. 9B illustrates rays emanating from a source in FIG. 9A to all receivers.

FIG. 10A illustrates a station distribution in accordance with some embodiments.

FIG. 10B illustrates simulated magnetic data in accordance with some embodiments.

FIG. 11 illustrates an example cross section of a single-domain inverted velocity model.

FIG. 12 illustrates an example cross section of a single-domain inverted susceptibility model.

FIG. 13 illustrates an example cross section of a jointly inverted velocity model.

FIG. 14 illustrates an example cross section of a jointly inverted susceptibility model.

FIG. 15 illustrates an example cross section of the ray coverage for the seismic domain.

FIGS. 16 and 17 are flow diagrams illustrating methods of multiple-domain inversion in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Computing Systems

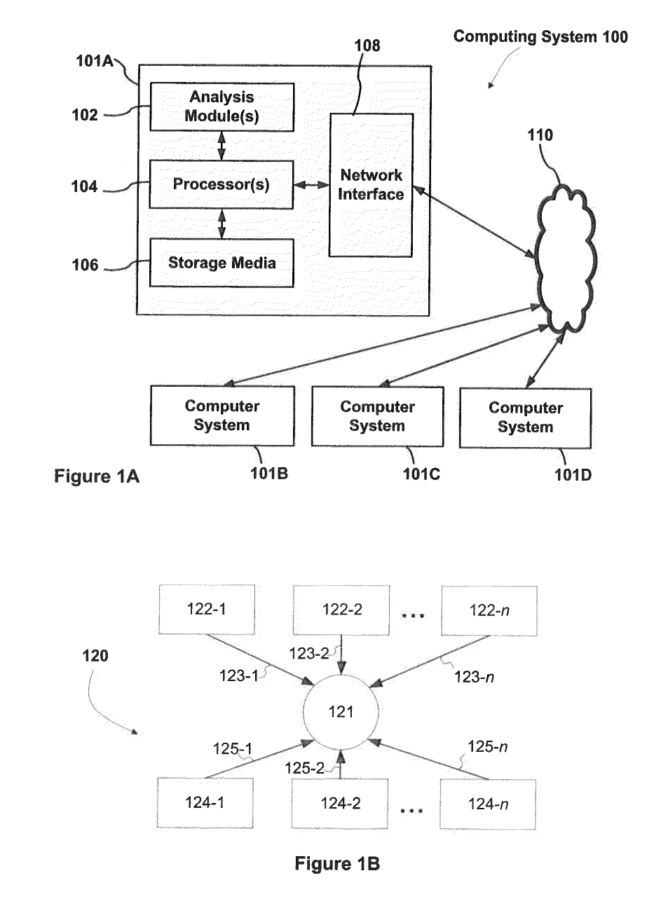

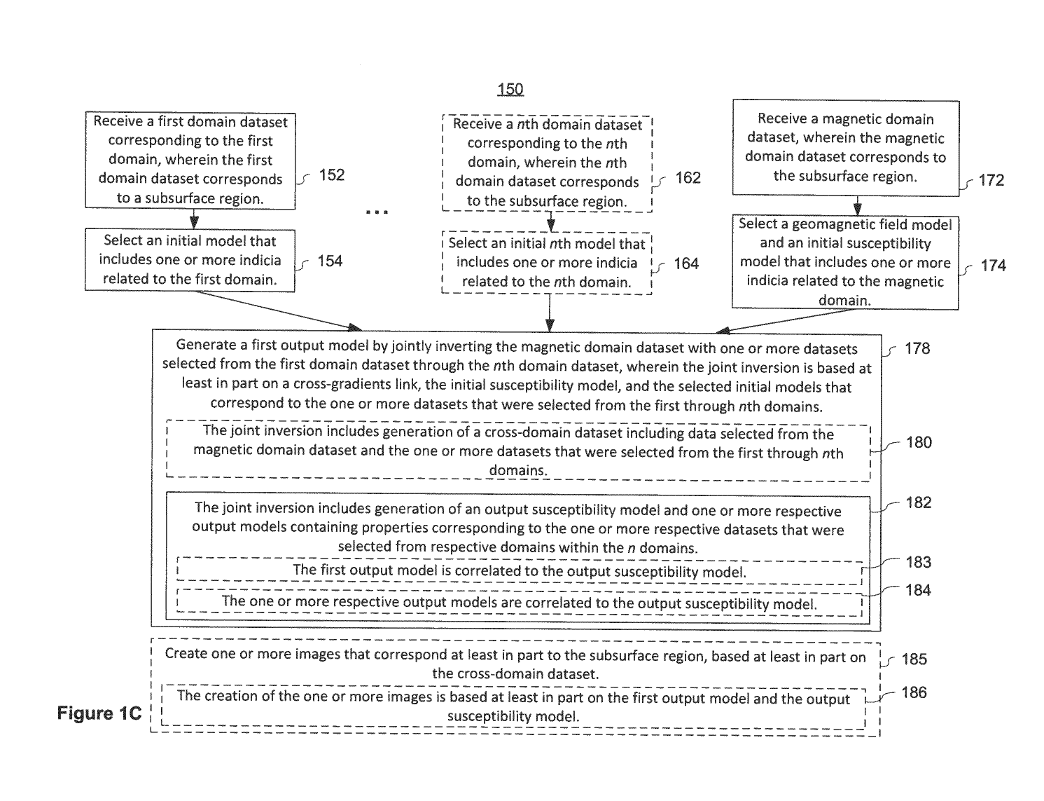

FIG. 1A depicts an example computing system 100 in accordance with some embodiments. The computing system 100 can be an individual computer system 101A or an arrangement of distributed computer systems. The computer system 101A includes one or more analysis modules 102 that are configured to perform various tasks according to some embodiments, such as the tasks depicted in FIGS. 1C, 16, and 17. To perform these various tasks, analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g. computer systems 101A and 101B may be on a ship underway on the ocean, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the exemplary embodiment of FIG. 1A storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the exemplary embodiment of FIG. 1A, and/or computing system 100 may have a different configuration or arrangement of the components depicted in FIG. 1A. The various components shown in FIG. 1A may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Joint Inversion Theory

Attention is now directed to FIG. 1B, which illustrates an example of a logical framework 120 for joint inversion according to some embodiments, and which may be implemented on a computing system such as computing system 100 of FIG. 1A.

Joint inversion core 121 can communicate with domain managers 122-1 through 122-n over links 123-1 through 123-n, respectively, where n is the number of domains to be jointly inverted. Similarly, joint inversion core 121 can communicate with link managers 124-1 through 124-n over links 125-1 through 125-n, respectively. In some embodiments, there is one domain manager for each model domain to be jointly inverted, and there is a link manager for each link function to be used, e.g., in some embodiments, domain manager 122-1 may be for processing a magnetic susceptibility domain, domain manager 122-2 may be for processing a seismic P-velocity domain, and there is a link manager 124-1 that manages the imposed relationship between magnetic susceptibility and seismic P-velocity. In this example non-limiting architecture, the joint inversion core 121 communicates with respective domain and link managers to retrieve respective values, gradients, and other relevant data relating to respective single domains and/or link objective functions to be used for inversion. Joint inversion core 121 can collect these respective values for use in joint inversion during one or more iterations of multi-domain joint inversion, which in some embodiments, can be performed in accordance with equation 7 or other suitable methods as discussed below.

Attention is now directed to FIG. 1C, which illustrates a workflow 150 for joint inversion according to some embodiments, and which may be implemented on a computing system such as computing system 100 of FIG. 1A, as well as in the context of a theoretical framework for joint inversion such as logical framework 120 of FIG. 1B.

As those with skill in the art will appreciate, combinations of data domains that can be jointly inverted can include magnetics and gravity, magnetic and full-tensor gradiometry, magnetics plus reflection tomography, magnetics plus magnetotellurics, magnetics plus surface-wave inversion, or any other suitable form of collected data, as well as adding one or more additional domains to the joint inversion so that three or more domains can be jointly inverted. In some embodiments, however, the techniques of workflow 150 may be employed effectively on just two domains, e.g. magnetic susceptibility and seismic P-velocity. In those cases, steps 162 and 164 would not be performed, and subsequent operations in workflow 150 would be adjusted accordingly since only two domains would be jointly inverted.

Further, joint inversion, in varying embodiments, can also be simultaneous joint inversion, concurrent joint inversion, synchronized joint inversion, or other forms of coordinated inversion, depending on any or all of the following considerations: the architecture of the computing system used for joint inversion, the operating system architecture, the programming language(s) used, application programming interface(s), etc. Additionally, those with skill in the art will appreciate that joint inversion can be carried out on multiple processor and/or multiple core computing systems, as well as on individual single processor computing systems by using threading, context switches between multiple processing routines that are operating on one or more domains to be jointly inverted, varying forms of interprocess control, communication, and/or coordination, etc.

In one aspect, an example process of joint inversion uses a workflow as illustrated in FIG. 1C. However, neither the techniques disclosed herein, nor this embodiment in particular, are restricted to this joint inversion process; rather, the disclosed embodiments can be applied successfully to any inversion procedure where inversion of a plurality of domains may be desirable.

FIG. 1C illustrates workflow 150 where, initially, a first domain dataset corresponding to a first domain is received (152). The first domain dataset corresponds to a subsurface region. For example, the first domain dataset may be collected seismic data representing a subterranean region being explored for hydrocarbons, though as discussed below, the first domain may correspond to other types of information, collected data and/or measurements as well.

Workflow 150 includes selecting an initial model that includes one or more indicia related to the first domain (154), e.g. velocity information. While not illustrated in FIG. 1C, in some embodiments, workflow 150 can include adjusting and/or preprocessing the first domain dataset.

As illustrated in FIG. 1C, additional domains can be processed in a similar fashion, e.g., steps 162 and 164 are illustrated to indicate that additional domain datasets can be processed (e.g., a second domain dataset, a third domain dataset if desired, and up through a nth domain dataset, where n is an arbitrary number). In some embodiments, the additional domain processing in steps 162 and 164 can be analogous to the processing performed in steps 152 and 154, though as those with skill in the art will appreciate, the processing for a given domain dataset would be adjusted as appropriate for the nature of the data in the domain to be processed. In alternate embodiments, other processing workflows can be used to generate an adjusted and/or preprocessed nth domain dataset and/or nth domain model for inversion of the nth domain dataset.

Workflow 150 also includes processing of a dataset related to a magnetic domain for susceptibility analysis. A magnetic domain dataset is received (172), wherein the magnetic domain dataset corresponds to the subsurface region. To facilitate processing of the magnetic domain dataset, a geomagnetic field model and an initial susceptibility model are selected (though those with skill in the art will appreciate that use of one or more models of varying forms can be configured to represent magnetic field(s) and susceptibility and be successfully employed by the methods and techniques disclosed herein) (174). While not illustrated in FIG. 1C, some embodiments include adjusting and/or preprocessing those model(s) and/or domain dataset(s) by any suitable technique, including but not limited to filtering to remove regional contributions, extracting magnetic anomalies, and other techniques as those with skill in the art will appreciate. After selecting initial model(s) as discussed above, a first output model is generated by jointly inverting the magnetic domain dataset with one or more datasets selected from the first domain dataset through the nth domain dataset, wherein the joint inversion is based at least in part on a cross-gradients link, the initial susceptibility model, and the selected initial models that correspond to the one or more datasets that were selected from the first through nth domains (178).

In some embodiments the joint inversion includes generation of a cross-domain dataset including data selected from the magnetic domain dataset and the one or more datasets that were selected from the first through nth domains. (180). In some embodiments, workflow 150 generating an output susceptibility model and one or more respective output models containing properties corresponding to the one or more respective datasets that were selected from respective domains within the n domains (182).

Generally, when jointly inverting multiple domains, the resulting models are all correlated with one another; this is a result of performing the inversions for the domains jointly. Accordingly, in some embodiments, the first output model is correlated to the output susceptibility model (183); the correlation may be based in part on one or more effects of a link function such as those discussed in connection with FIG. 1B. Similarly, in some embodiments, the one or more respective output models are correlated to output susceptibility model (184).

In some embodiments, workflow 150 includes creating one or more images that correspond at least in part to the subsurface region, wherein the image creation is based at least in part on the cross-domain dataset (185). In some embodiments, the creation of the one or more images is based at least in part on the first output model and the output susceptibility model (186); in other embodiments, the creation of the one or more images is based at least in part on the output susceptibility model and the one or more respective output models.

Following evaluation of the output and/or preprocessed models, images, and/or datasets, additional iterations of workflow 150 may be performed to further refine the models, datasets and/or images to generate a revised cross-domain dataset and/or models. As those with skill in the art will appreciate, multiple iterations of one or more steps of workflow 150 may be performed to continue to improve a cross-domain dataset and/or models to create an improved image.

Attention is now directed to examples of some equations that can be used to calculate, estimate, or derive various metrics in the workflows discussed here.

In some embodiments, induced magnetization can be calculated, estimated, and/or derived from equation 1, which can be expressed as:

$$M = \frac{χ}{{μ}_{0} ( 1 + χ )} {B}_{0} \qquad ( 1 )$$

where M represents the induced magnetization, X represents magnetic scalar susceptibility, μ₀ represents magnetic permeability of the vacuum, and B₀ represents the inducing magnetic field.

In some embodiments, measured magnetic fields associated with hypothetical uniformly magnetized right rectangular prisms utilized for modeling purposes can be calculated, estimated, and/or derived from equation 2, which can be expressed as:

$$ξ ( p ) = \frac{{μ}_{0}}{4 π} {\int }_{V} \frac{[ ( 3 \hat{m} \cdot \hat{r} ) \hat{r} - \hat{m} ] \cdot \hat{b}}{{r}^{3}} d v \qquad ( 2 )$$

where P represents the vector identifying the measurement position, r represents the scalar distance between the volumetric element dv and the position P, \hat{r} is a versor oriented from dv towards P, \hat{m} is the magnetization versor, and \hat{b} is the geomagnetic versor at the measurement position P.

In some embodiments, a magnetic anomaly, Bᵢ, can be used to model a forward magnetic problem. For example, a set of Green's function coefficients may be disposed in a matrix. The magnetic anomaly, Bᵢ, can be calculated, estimated, and/or derived from equation 3, which can be expressed as:

Bᵢ=ξᵢⱼ(pⱼ)Mⱼ (3)

where ξᵢⱼ is the (i,j)th element of the matrix.

In some embodiments, a magnetic domain inversion can include reduction or minimization of an objective function Φ(m), which can be calculated, estimated, and/or derived as represented by equation 4:

$$Φ ( m ) = {\vert {W}_{d} ( g ( m ) - d ) \vert}^{2} + {\int }_{V} Γ ( m - {m}_{pri} ) d v \qquad ( 4 )$$

where g(m) represents a vectorial function of the magnetization used to perform forward modeling, W_{d} represents a diagonal matrix of data weights, d is the vector of observed data, mₚᵣᵢ represents an a-priori model function, and Γ is a regularization function.

In some embodiments, a regularization function, Γ, can be calculated, estimated, and/or derived according to equation 5:

$$Γ ( m - {m}_{pri} ) = {α}_{s} {\{ w [ m - {m}_{pri} ] \}}^{2} + {α}_{x} {\{ \frac{\partial w [ m - {m}_{pri} ]}{\partial x} \}}^{2} + {α}_{y} {\{ \frac{\partial w [ m - {m}_{pri} ]}{\partial y} \}}^{2} + {α}_{z} {\{ \frac{\partial w [ m - {m}_{pri} ]}{\partial z} \}}^{2} \qquad ( 5 )$$

where αₛ, αₓ, α_{y}, and α_{z} are coefficients that affect the relative importance of different components in the regularization function, and w is a weighting function, which in some embodiments may depend on forward sensitivity and be indicative of the potential field decay; in some embodiments, this weighting function may be expressed according to equation 6:

$$w = {‖ \frac{d g}{d m} ‖}_{2} \qquad ( 6 )$$

In some embodiments, a two-domain joint inversion, Φ_{SJI}(m), can be calculated, estimated, and/or derived according to equation 7:

$${Φ}_{SJI} ( m ) = {α}_{1} {Φ}_{1} ( {m}_{1} ) + {α}_{2} {Φ}_{2} ( {m}_{2} ) + β {\int }_{U} Ψ ( m ) d v \qquad ( 7 )$$

where m is a vector containing model functions m₁ and m₂, Φ₁ is an objective function of a magnetic inversion, Φ₂ is an objective function of another inversion domain, Ψ is a link function between the domains, which in some embodiments is only active in the user-defined spatial region U that contains values for the two domain models, and α₁, α₂, □ and are relative weights of the domains and of the link between the domains. As those with skill in the art will appreciate, the two-domain joint inversion of equation 7 can readily be expanded to an n-domain joint inversion.

In some embodiments, when a domain component includes a magnetic objective function, use of a cross-gradients constraint as a link function, Ψ, can be calculated, estimated, and/or derived according to equation 8:

Ψ(m₁,m₂)=|□m₁×□m₂|² (8)

where □ represents a gradient, m₁ is the model of the first domain, and m₂ is the model of the second domain.

Attention is now directed to other aspects of theory and implementation of a specific non-limiting example of multi-domain joint inversion that can be expanded to jointly inverting n domains.

The total field acquisition records the amplitude of the magnetic vector for each measurement position, though in some embodiments, one or more measurement positions can be processed partially for field analysis. Further, in some embodiments, magnetic tensor measurements can be employed, and in further embodiments, the total field acquisition and magnetic tensor measurements can be employed jointly. Although an anomalous magnetization in the subsurface slightly modifies the direction of the measured field, in some cases, one can assume that the instruments have detected only the amplitude along the direction of the Earth field (Blakely, 1996). Furthermore, in a simplified case where any remanent magnetization is absent (Li and Oldenburg, 1996), subsurface magnetization is completely (or substantially) induced by the geomagnetic field. Neglecting anisotropy, the induced magnetization can be considered substantially parallel to the inducing field and can be calculated, derived or generated in accordance with equation 1, variations of equation 1, or alternative means as those with skill in the art will appreciate.

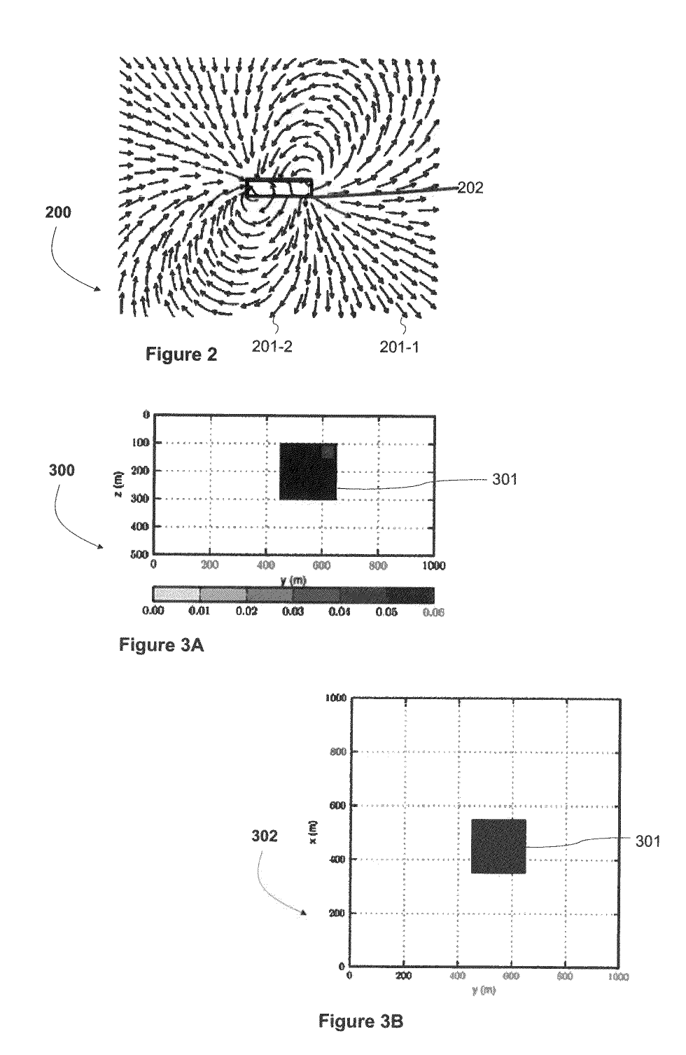

For forward modeling, one can divide the subsurface into one or more right rectangular prisms with constant magnetization, and a total field anomaly exploiting the superposition principle can be built. As a non-limiting example in accordance with some embodiments, FIG. 2 depicts streamlines (201-1, 201-2, etc.) for a magnetic field 200 generated by a right rectangular prism 202 with magnetization inclined by 30 degrees. The Green's function of the measured magnetic field caused the prism can be calculated, derived or generated in accordance with equation 2, variations of equation 2, or alternative means as those with skill in the art will appreciate. In the example of equation 2, the integrand is the projection of the Green's function of an element magnetic dipole on the direction of the inducing field B0.

Interpretation of magnetic anomalies is generally more difficult than interpretation of gravity anomalies. This is due to the change in shape of the magnetic response related to changes in the inclination and declination of the geo-magnetic field.

FIG. 3A shows a susceptibility model 300 containing a buried cube 301, with uniform susceptibility, where the cross section is at y=500 meters, and FIG. 3B shows a plan section 302, with z=100 meters. The x axis points to the geographic North in FIGS. 3A and 3B.

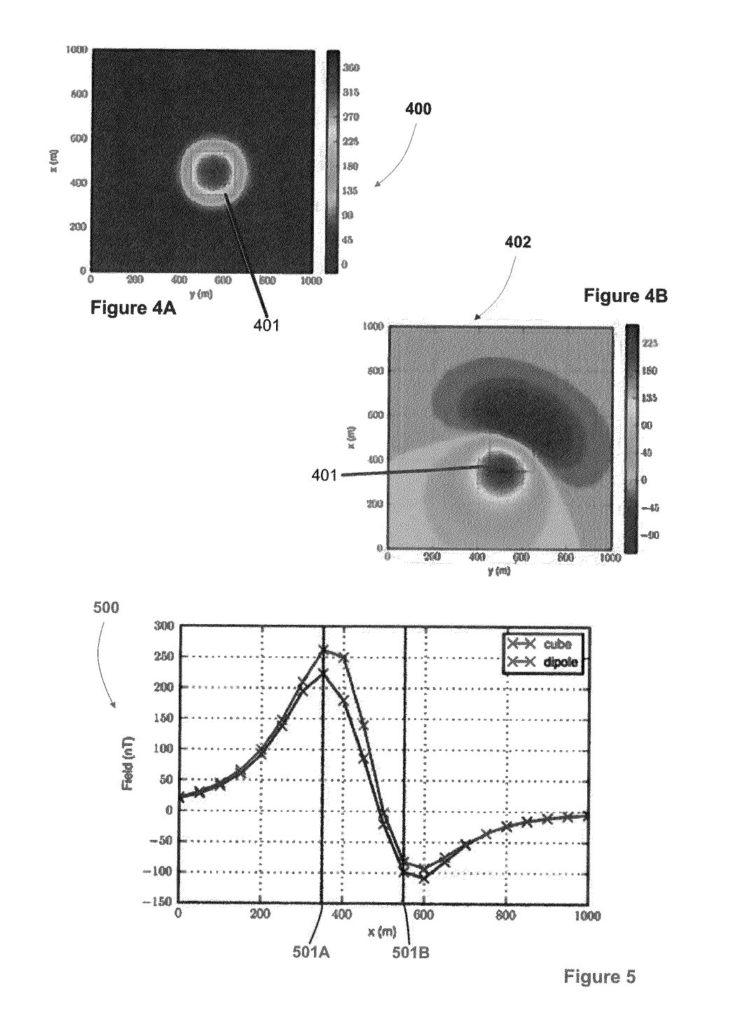

FIGS. 4A and 4B illustrate magnetic anomalies caused by the buried cube 301 of FIG. 3. Specifically, the example of FIG. 4A illustrates a plan view 400 of the magnetic anomaly (nT) caused by the cube of FIG. 3 when the inducing geomagnetic field is 50 μT. In FIG. 4A, the inclination is 90 degrees (i.e., a measurement performed at the North Pole); in FIG. 4B, however, the inclination of the geomagnetic field is 44 degrees and declination is 25 degrees of the plan view 402. The boundaries of the cube 401 are highlighted by a black box in both FIGS. 4A and 4B.

The results of FIGS. 4A and 4B indicate that, in some situations, interpretation of data measured at the pole can be easier than at other locations. Accordingly, interpretation can be aided by a reduction to the pole in some cases. Reduction to the pole is a transformation that modifies the phase of measured data. The result is the signal that would have been recorded if the measurement was taken at the pole. Although very useful for interpretation, this operation is not needed for inversion. Furthermore, in most datasets, as one approaches the magnetic equator, the noise is amplified when a reduction to the pole is performed (Blakely, 1996). For this reason, in some datasets, it can be beneficial to invert data that have not been reduced to the pole.

Verification of the implemented magnetic forward can be done in varying ways. For example, one can substitute the cube in FIG. 3 with an equivalent magnetic dipole, then compare the field produced with that of an infinitesimal dipole; an example of this comparison is illustrated in FIG. 5, which shows a comparison 500 between the field of the cube in FIG. 3 and that of an equivalent dipole on a profile at y=500 meters when the geomagnetic field is 50 μT, inclination is 44 degrees and declination is 25 degrees. Vertical black lines 501A and 501B delimit the position of the cube in the subsurface. As the plot shows, the farther one gets from the cube, the more the two fields are equal. This verifies the far field conditions. In the far field approximation, the field of any magnetized body is equivalent to the field generated by an equivalent, infinitesimal, magnetic dipole.

For forward computation, the Jacobian matrix of the problem can be built to aid analysis, and can be computed as follows. The magnetic anomaly Bi caused by cell j on the measurement position i can be calculated, derived, or generated in accordance with equation 3, variations of equation 3, or alternative means as those with skill in the art will appreciate.

While different approaches to magnetic single domain inversion can be utilized, one example approach is similar to that of Li and Oldenburg, 1996, but with three principal differences regarding: a) the inverted unknown; b) the adopted positivity constraint; and c) the chosen solver algorithm.

In some instances, and the example here, the inverted unknown, e.g., susceptibility or magnetization, may be estimated through minimization of an objective function, such as the example equation 4, that is carried out with respect to the 3D magnetization function m, rather than with respect to the susceptibility directly. This choice is driven by the consideration that, as shown by equation 3, the relation between magnetization and magnetic anomalies is linear, while that between susceptibility and magnetic anomaly is not linear.

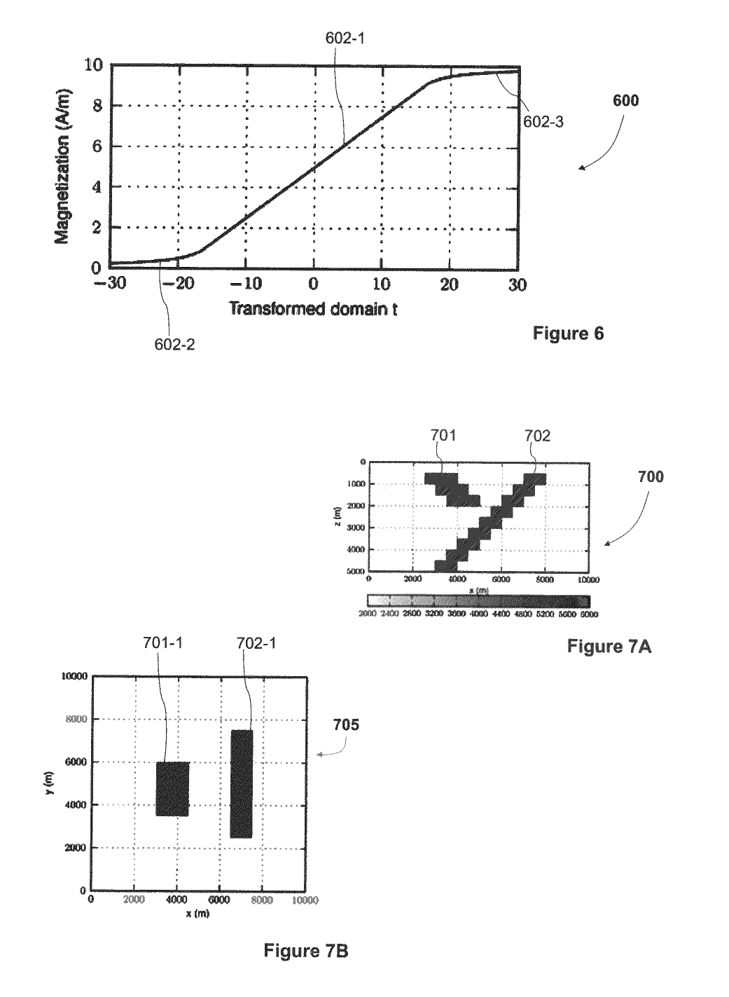

With respect to the positivity constraint, a double-limiting quasi-linear function, such as the non-limiting example shown in FIG. 6, can be used. FIG. 6's function 600 illustrates a transformed domain t which spans the interval (−∞, +∞), where the model domain spans the interval (0, 10) A/m. The central part of the limiter 602 is a straight line 602-1, while the end branches are hyperbolas, 602-2 and 602-3. If m is the magnetization variable, m=f (t) is set, where t is the unknown in the transformed domain and f is the limiter of FIG. 6. Then, the inverse problem is solved into the transformed domain. The final solution, is then back converted to the anti-transformed domain through the function of FIG. 6. The limiter of FIG. 6 is completely parametric, in the sense that its slope and its asymptotes can be chosen by the user. As those with skill in the art will appreciate, other functions can be used for this purpose.

In this example, the solver is an implementation of a nonlinear conjugate gradients (NLCG) algorithm (Teukolsky et al., 2007). The usage of a nonlinear solver allows the performance of joint inversions with other nonlinear inversion domains, such as magnetotellurics, when performing multi-domain joint inversions.

When one of the components Φi is a magnetics objective function, use of a cross-gradients constraint as a link function can be beneficial. One example is provided above as equation 8, though variations of equation 8, or alternative means as those with skill in the art will appreciate can be used for this purpose.

Attention is now directed to a non-limiting example of joint inversion including magnetization and output models corresponding to varying domains. While this example was a simulation, though as those with skill in the art will appreciate that these techniques and variations of these techniques can be applied successfully to collected data sets corresponding to actual physical regions of interest in varying arts, such as exploration for hydrocarbons.

FIG. 7A shows a velocity model in one cross section 700 at y=5000 meters, while FIG. 7B shows a plan section 705 at z=1250 meters. In this example the velocity model consists of two dikes 701, 702 (as depicted in FIG. 7A, and 701-1 and 702-1 in FIG. 7B). The dikes 701 and 702 dip in opposite directions and have different widths and lengths, but they have the same x strike direction (e.g., a direction perpendicular to x). The velocities of the two dykes are 5000 m/s and 6000 m/s respectively. The background velocity is 2000 m/s.

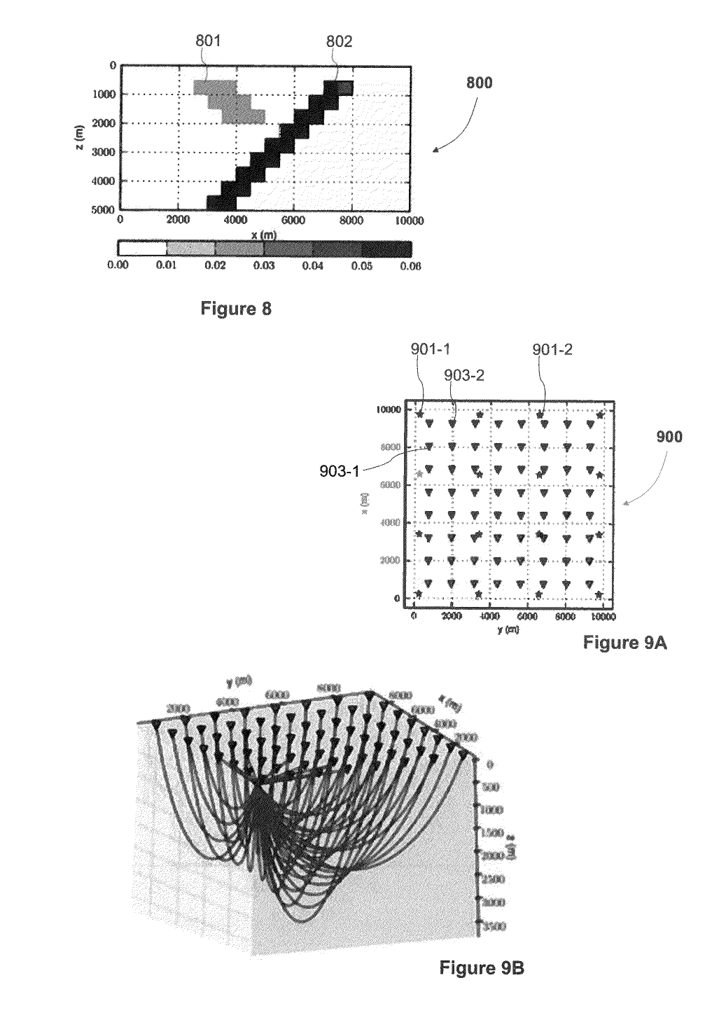

The corresponding susceptibility model 800 is shown in FIG. 8, and is a cross section at y=5000 meters. The susceptibilities of the two dykes 801 and 802 are 0.02 and 0.06 respectively. The background susceptibility is zero.

For the seismic domain in this example, first-arrival times are calculated with respect to 16 sources and 64 receivers. FIG. 9A illustrates the layout 900 with sources (stars 901-1, 901-2, etc.) and receivers (triangles 903-1, 903-2, etc.) distribution for the first breaks simulation. FIG. 9B illustrates rays from one source to all the receivers. In this particular example, sources are evenly distributed on the surface with a spacing of about 3160 m in both x and y directions; receivers have an equal spacing of about 1200 m in x and y. A total of 1024 first-arrival times were calculated in this example, and a zero-mean, random, white Gaussian noise with a 10 ms standard deviation was added to each data sample. The two model domains have the same sampling, with 20 cells along x, 20 along y, and 10 along z. The initial seismic model is a vertical velocity gradient with a starting velocity of 2500 m/s and a final velocity of 5500 m/s. The initial magnetic model is a volume with a uniform susceptibility of 0.

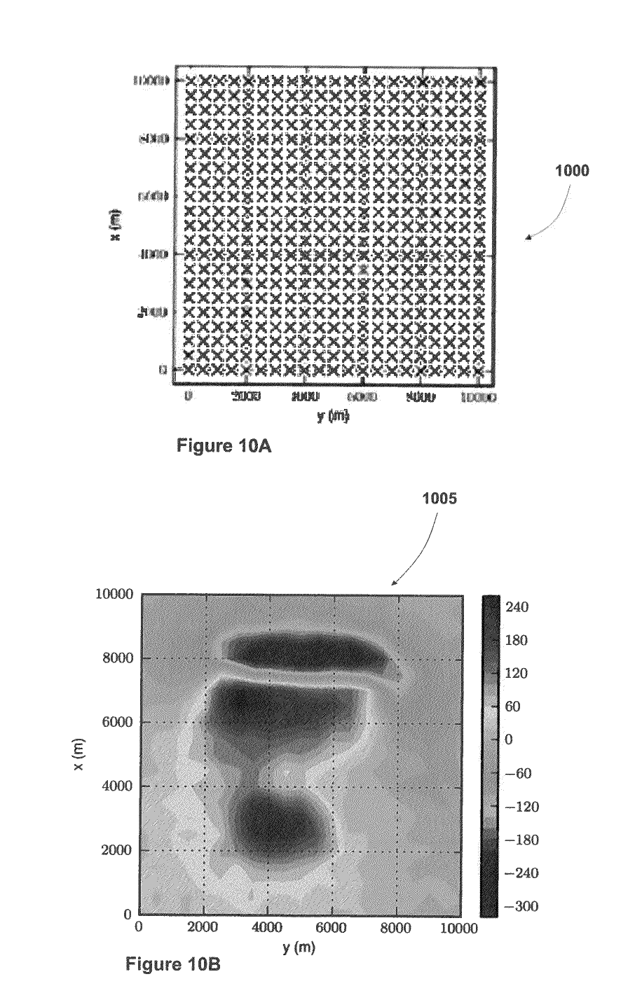

For the susceptibility domain, a total magnetic field anomaly is produced given assumptions that the geomagnetic field is 50000 nT and has an inclination of 44 degrees and a declination of 25 degrees. The spacing between stations is 500 m in both directions. FIG. 10A illustrates a station distribution 1000 of the 441 stations for the magnetic simulation. Measurements were recorded on the surface at 441 evenly spaced stations, and a zero-mean, random, white Gaussian noise with a 10 nT standard deviation was added to each data sample. FIG. 10B depicts simulated magnetic data 1005. Note that the x axis points to the North geographic pole (which is a common convention for magnetic dataset representations).

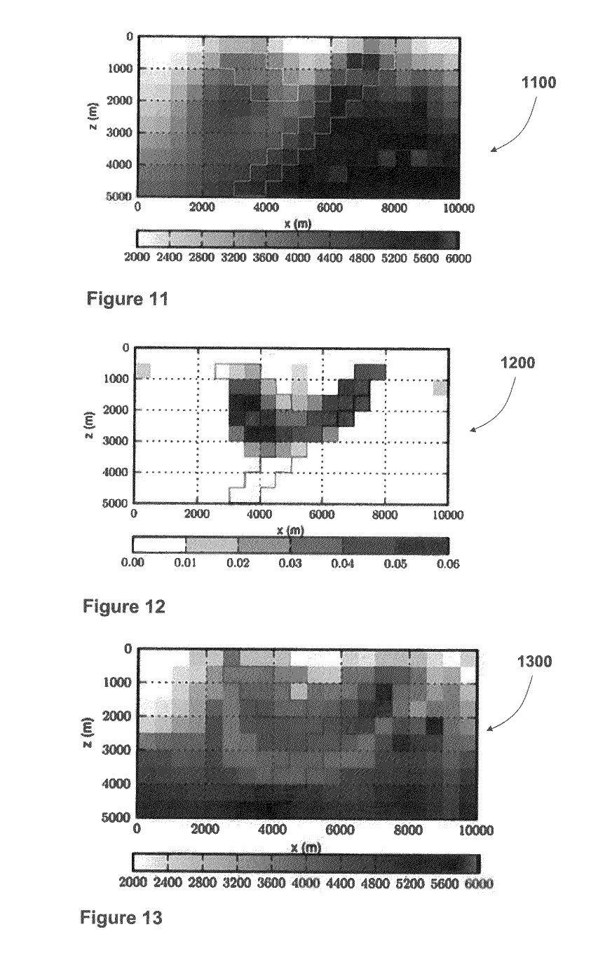

FIG. 11 and FIG. 12 show the inverted models coming from the first run of single-domain refraction tomography and magnetic inversions, respectively. Specifically, FIG. 11 is a cross section 1100 at y=5000 meters of the single-domain inverted velocity model. The susceptibility is obtained by back-converting the output scalar magnetization into susceptibility, using the inverse expression of equation 1. The velocity section is very smooth and presents only light hints of the true dykes structure.

On the other hand, the magnetic result as illustrated in FIG. 12, which is a cross section at y=5000 meters of the single-domain inverted susceptibility model 1200 presents a more focused image, with a loss of resolution with increasing depth. This is a well-known problem of all potential field methods and it is the reason why the dyke on the right is not fully recovered in all its length.

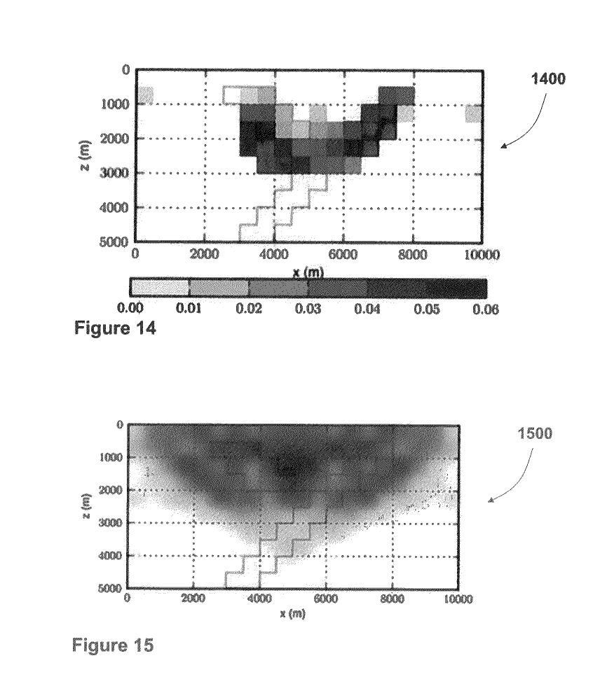

FIG. 13 and FIG. 14 show the outputs of a SJI with the cross-gradients link. Specifically, FIG. 13 illustrates a cross section 1300 at y=5000 meters of the velocity model that underwent joint inversion with the susceptibility domain. In FIG. 13, the shapes of the dykes are more focused than in FIG. 11. Note also how the high-velocity zone that was present in the lower right part of FIG. 11 has disappeared in FIG. 13. Furthermore, it is evident that the sharper focusing achieved by the magnetic inversion is also present in the seismic domain. FIG. 15, which is a cross section 1500 at y=5000 meters of ray coverage for the seismic domain, illustrates the features visible in FIG. 13 for a single run. Enhancement of inversion results could be achieved with more than one run and/or with additional ray tracing over what was done in seismic inversion alone.

Regarding the susceptibility domain, as shown in FIG. 14, which illustrates a cross section 1400 at y=5000 meters of the susceptibility model that underwent joint inversion with the seismic domain, has better focusing than that of FIG. 12.

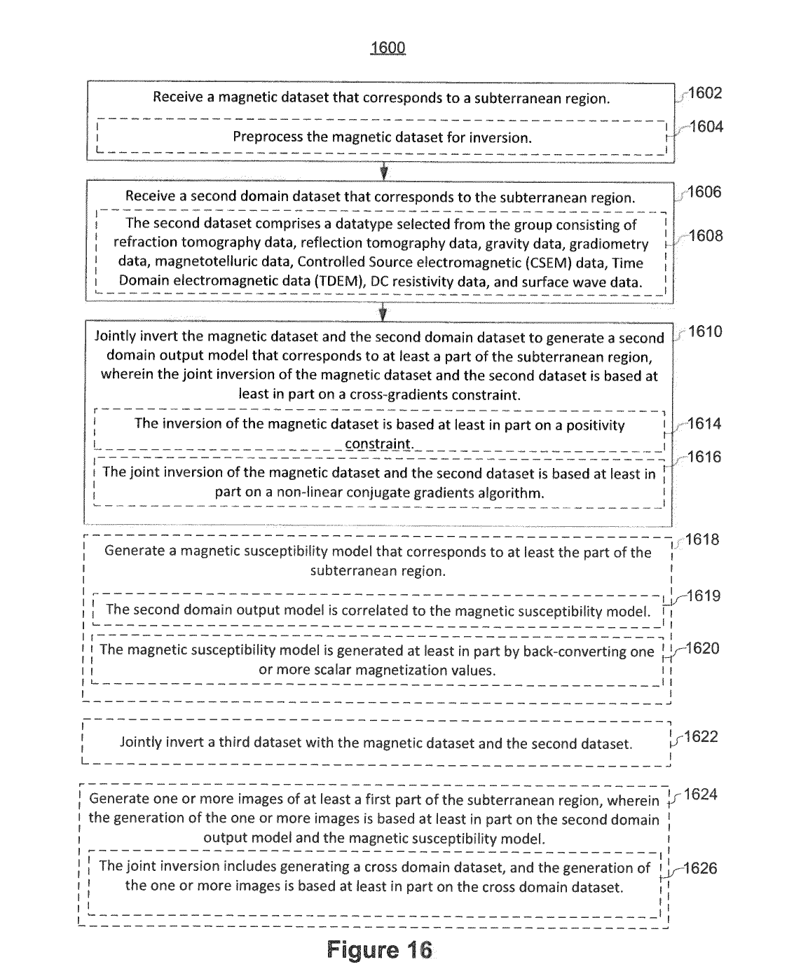

Attention is now directed to FIG. 16, which is a flow diagram illustrating a method of joint inversion in accordance with some embodiments. Some operations in method 1600 may be combined and/or the order of some operations may be changed. Further, some operations in method 1600 may be combined with aspects of the example work flow of FIG. 1C, and/or the order of some operations in method 1600 may be changed to account for incorporation of aspects of the work flows illustrated by FIG. 1C. Additionally, operations in method 1600 may be combined with aspects of method 1700 discussed below, and/or the order of some operations in method 1600 may be changed to account for incorporation of aspects of method 1700.

It is important to recognize that geologic interpretations, sets of assumptions, and/or domain models such as velocity or magnetization models, may be refined in an iterative fashion; this concept is applicable to methods 1600 and 1700 as discussed herein, as well as the workflow 150 described above and in FIG. 1C. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate for the evaluation of a subsurface three-dimensional geologic formation under consideration.

The method 1600 is performed at a computing device (e.g., computing system 100, FIG. 1A). In some embodiments, the method 1600 is performed using a logical framework for joint inversion (e.g., logical framework 120, FIG. 1B).

The method 1600 includes receiving (1602) a magnetic dataset that corresponds to a subterranean region (e.g., step 172, FIG. 1C). In some embodiments, method 1600 also includes preprocessing the magnetic dataset for inversion (1604).

The method 1600 includes receiving (1606) a second dataset that corresponds to the subterranean region (e.g., step 152 or 162, FIG. 1C). In some embodiments, the second dataset comprises a datatype selected from the group consisting of seismic data, refraction tomography data, reflection tomography data, gravity data, full-tensor gradiometry data, magnetotelluric data, Controlled Source electromagnetic (CSEM) data, Time Domain electromagnetic data (TDEM), surface wave data and DC resistivity data (1608).

The method 1600 includes jointly inverting (1610) the magnetic dataset and the second domain dataset to generate a second domain output model that corresponds to at least a part of the subterranean region, wherein the joint inversion of the magnetic dataset and the second dataset is based at least in part on a cross-gradients constraint. (e.g., step 178, FIG. 1C). In some embodiments, joint inversion is simultaneous joint inversion. In some embodiments, the joint inversion is non-linear.

The second domain output model corresponds to the type of data within the second domain, e.g., for seismic data, a velocity model is generated; for refraction tomography data, a P-velocity model is generated; for reflection tomography data, a P-velocity model is generated; for surface wave data, an S-velocity model is generated; for gravity data, a density model is generated; for Full Tensor Gradiometry data, a density model is generated; for magnetic data, a susceptibility model is generated; for magnetotellurics, a resistivity model is generated; for DC resistivity data a resistivity model is generated; and as those with skill in the art will appreciate, appropriate models will be generated for any given domain to be jointly inverted.

In some embodiments, the inversion of the magnetic dataset is based at least in part on a positivity constraint, such as a double-limiting quasi-linear function (1614).

In some embodiments, the joint inversion of the magnetic dataset and the second dataset is based at least in part on a non-linear conjugate gradients algorithm (1616).

In some embodiments, method 1600 includes generating a magnetic susceptibility model that corresponds to at least the part of the subterranean region (1618) (e.g., step 176, FIG. 1C).

In some embodiments, the second domain output model is correlated to the magnetic susceptibility model (1619). In some embodiments, the correlation is based at least in part on the effect of the link function. Similarly, the magnetization model is correlated to the second domain output model.

In some embodiments, the magnetic susceptibility model is generated at least in part by back-converting one or more scalar magnetization values, which in some embodiments, may be calculated from the inverse expression of equation 1, variations of equation 1, or other suitable techniques as those with skill in the art will understand. (1620).

In some embodiments, method 1600 also includes jointly inverting a third dataset associated with a third domain with the magnetic dataset and the second dataset to generate a third domain output model associated with the third domain (1622) (e.g., step 178, FIG. 1C). The third dataset can be any of the types described above, or other data types that correspond to collected data for imaging. Further, the process of jointly inverting datasets is not limited to two or three datasets, but can include an arbitrary number of n data types (e.g., steps 162, 164, and 178 FIG. 1C). While not explicitly mentioned in method 1600, incorporation of additional data types for joint inversion includes the requisite processing and initial model selection, such as steps 162 and 164 before joint inversion.

In some embodiments, method 1600 also includes generating one or more images of at least a first part of the subterranean region, wherein the generation of the one or more images is based at least in part on the second domain output model and the magnetic susceptibility model (1624) (e.g., step 186, FIG. 1C).

In some embodiments, the joint inversion also includes generating a cross domain dataset, and the generation of the one or more images is based at least in part on the cross domain dataset, as well as the second domain output model and the magnetic susceptibility model (1626) (e.g., steps 185 and 186, FIG. 1C). In some embodiments, generation of the one or more images can also be based in part on output models associated with other domains, e.g., a third domain dataset as discussed above with respect to step 1622.

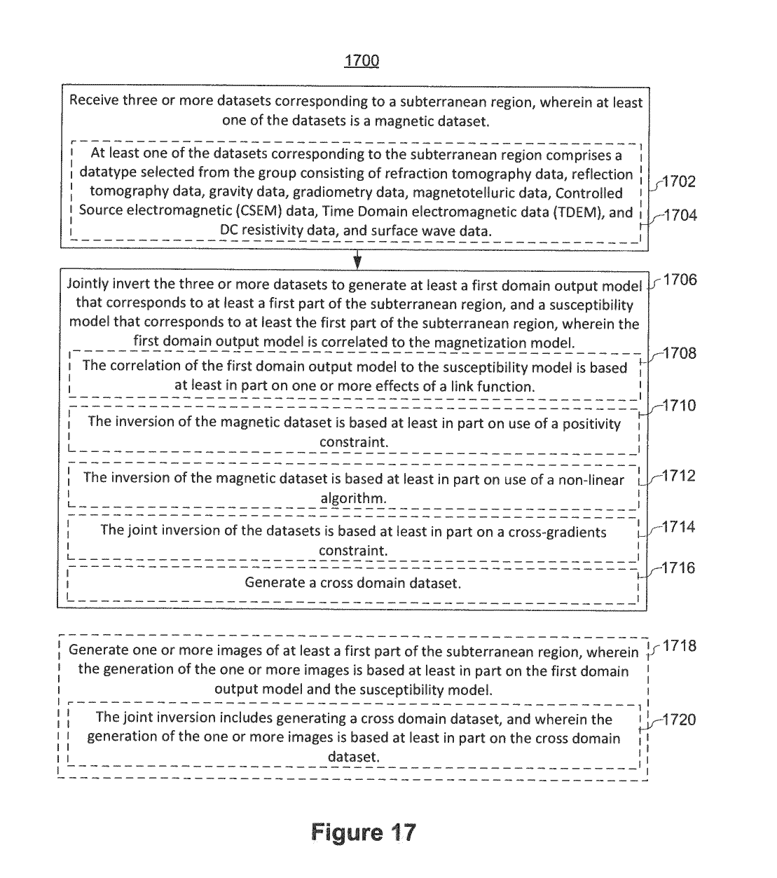

Attention is now directed to FIG. 17, which is a flow diagram illustrating a method of joint inversion in accordance with some embodiments. Some operations in method 1700 may be combined and/or the order of some operations may be changed. Further, some operations in method 1700 may be combined with aspects of the example work flow of FIG. 1C, and/or the order of some operations in method 1700 may be changed to account for incorporation of aspects of the work flow illustrated by FIG. 1C. Additionally, operations in method 1700 may be combined with aspects of method 1600 discussed above, and/or the order of some operations in method 1700 may be changed to account for incorporation of aspects of method 1600.

The method 1700 is performed at a computing device (e.g., computing system 100, FIG. 1A). In some embodiments, the method 1700 is performed using a logical framework for joint inversion (e.g., logical framework 120, FIG. 1B).

The method 1700 includes receiving (1702) three or more datasets corresponding to a subterranean region, wherein at least one of the datasets is a magnetic dataset (e.g., steps 152, 162, and 172, FIG. 1C).

In some embodiments, at least one of the datasets corresponding to the subterranean region comprises a datatype selected from the group consisting of seismic data, refraction tomography data, reflection tomography data, gravity data, gradiometry data, magnetotelluric data, Controlled Source electromagnetic (CSEM) data, Time Domain electromagnetic data (TDEM), surface wave data and DC resistivity data (1704).

The method 1700 includes jointly inverting (1706) the three or more datasets to generate a first domain output model that corresponds to at least a first part of the subterranean region (e.g., step 178, FIG. 1C), and a susceptibility model that corresponds to at least the first part of the subterranean region (e.g., step 182, FIG. 1C). In some embodiments, the first domain output model and the susceptibility model are correlated.

In some embodiments, the joint inversion also includes generating a second domain output model that corresponds to at least a first part of the subterranean region. In some embodiments, the first domain output model, the second domain output model, and the susceptibility model are correlated.

In some embodiments, the joint inversion may include jointly inverting n datasets and a magnetic dataset, wherein a susceptibility model that corresponds to at least the first part of the subterranean region is generated, and wherein respective output models corresponding to respective domains in the n domains are generated. In some embodiments, the respective output models and the susceptibility model are correlated.

As discussed above, appropriate models will be generated for any given domain to be jointly inverted, e.g. velocity models for seismic, density models for gravity, etc.

In some embodiments, the correlation of the first domain output model to the susceptibility model is based at least in part on one or more effects of a link function (1708).

In some embodiments, the inversion of the magnetic dataset is based at least in part on use of a positivity constraint (1710).

In some embodiments, the inversion of the magnetic dataset is based at least in part on use of a non-linear algorithm (1712).

In some embodiments, the joint inversion of the datasets is based at least in part on a cross-gradients constraint (1714) (e.g., step 178, FIG. 1C).

In some embodiments, a cross domain dataset is generated during the joint inversion (1716) (e.g., step 180, FIG. 1C).

In some embodiments, one or more images are generated of at least a first part of the subterranean region, wherein the generation of the one or more images is based at least in part on the first domain output model and the susceptibility model (1718) (e.g., step 186, FIG. 1C).

In some embodiments, the joint inversion includes generating a cross domain dataset, and the generation of the one or more images is based at least in part on the cross domain dataset, as well as the first domain output model and the susceptibility model (1720) (e.g., steps 185 and 186, FIG. 1C).

While certain implementations have been disclosed in the context of seismic data collection and processing, those with skill in the art will recognize that the disclosed methods can be applied in many fields and contexts where data involving structures arrayed in a three-dimensional space may be collected and processed, e.g., medical imaging techniques such as tomography, ultrasound, MRI and the like, SONAR and LIDAR imaging techniques and the like.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Various references that provide further information have been referred to above, and each is incorporated by reference.
S. B., W. D. Gropp, L. C. McInnes, and B. F. Smith. Efficient management of parallelism in object oriented numerical software libraries. In E. Arge, A. M. Bruaset, and H. P. Langtangen, editors, Modern Software Tools in Scientific Computing, pages 163-202. Birkh\ddot{}auser Press, 1997.
S. Balay, K. Buschelman, V. Eijkhout, W. D. Gropp, D. Kaushik, M. G. Kne-pley, L. C. McInnes, B. F. Smith, and H. Zhang. PETSc users manual. Technical Report ANL-95/11—Revision 3.0.0, Argonne National Laboratory, 2008.
S. Balay, K. Buschelman, W. D. Gropp, D. K., M. G. Knepley, L. C. McInnes, B. F. Smith, and H. Zhang. PETSc Web page, 2009. http://www.mcs.anr.gov/petsc.
B. K. Bhattacharyya. Magnetic anomalies due to prism-shaped bodies with arbitrary polarization. Geophysics, 29(04):517-531, 1964.
R. J. Blakely. Potential Theory in Gravity and Magnetic Applications. Cam-bridge University Press, 1996.
M. Commer, Three-dimensional gravity modeling and focusing inversion using rectangular meshes, Geophysical Prospecting, vol. 59, no. 5, 966-979, September 2011
M. De Stefano. Simultaneous joint inversion for susceptibility and velocity. In 81st Annual International Meeting. SEG, Expanded Abstracts, 2011.
M. De Stefano, F. G. Andreasi, S. Re, M. Virgilio and F. F. Snyder, Multiple-domain, simultaneous joint inversion of geophysical data with application to subsalt imaging, Geophysics, vol. 76, no. 3, R69 (2011)
M. De Stefano and D. Colombo. Pre-stack depth imaging via simultaneous joint inversion of seismic, gravity and magnetotelluric data. In 69th EAGE Cohference and Exhibition. EAGE, Extended Abstracts, 2007.
L. A. Gallardo and M. A. Meju. Joint two-dimensional dc resistivity and seismic travel time inversion with cross-gradients constraints. Journal of Geophysical Research, 109:B03311,doi:10.1029/2003JB002716, 2004.
R. I. Gibson and P. S. Millegan. Geologic applications of gravity and magnetics: case histories, volume 8 of SEG Geophysical References. SEG and AAPG, 1998.
Y. Li and D. W. Oldenburg. 3-D inversion of magnetic data. Geophysics, 61 (02):394-408, 1996.
Y. Li and D. W. Oldenburg. 3-D inversion of gravity data. Geophysics, 63(01):109-119, 1998.
Y. Li and D. W. Oldenburg. Joint inversion of surface and three-component borehole magnetic data. Geophysics, 65(02):540-552, 2000.
D. B. Rao and N. R. Babu. A rapid method for three-dimensional modeling of magnetic anomalies. Geophysics, 56(11):1729-1737, 1991.
S. A. Teukolsky, W. T. Vetterling, and B. P. Flannery. Numerical Recipes—The Art of Scientific Computing. William H. Press, 2007.
M. Virgilio, S. Hallinan, and M. Mantovani. Simultaneous joint inversion of electromagnetic, gravity and seismic data for thrust belt and sub-basalt imaging. In 10th Simposio Bolivariano. EAGE, Extended Abstracts, 2009.
M. Virgilio, M. De Stefano, S. Re, F. Golfré Andreasi, and F. F. C. Snyder. Simultaneous joint inversion of seismic, gravity, and EM data for subsalt depth imaging in Gulf of Mexico. In 72nd EAGE Conference and Exhibition. EAGE, Extended Abstracts, 2010.
U.S. Patent App. Pub. No. US 2010/0014384, Method for building velocity models for pre-stack depth migration via the simultaneous joint inversion of seismic, gravity, and magnetotelluric data.
U.S. Pat. No. 7,805,250, Methods and apparatus for geophysical exploration via joint inversion.
U.S. Pat. No. 7,504,829, Methods And Apparatus For Subsurface Geophysical Exploration Using Joint Inversion Of Steady-State And Transient Data.
U.S. Patent App. Pub. No. US 2011/0134722, Simultaneous joint inversion of surface wave and refraction data.

What is claimed is:

1. A method, comprising:
receiving a magnetic dataset that corresponds to a subterranean region;
receiving a second domain dataset that corresponds to the subterranean region; and
jointly inverting the magnetic dataset and the second domain dataset to generate a second domain output model, wherein:
the second domain output model corresponds to at least a part of the subterranean region, and
the joint inversion of the magnetic dataset and the second dataset is based at least in part on a cross-gradients constraint.

2. The method of claim 1, further comprising generating a magnetic susceptibility model that corresponds to at least the part of the subterranean region.

3. The method of claim 2, wherein the magnetic susceptibility model is generated at least in part by back-converting one or more scalar magnetization values.

4. The method of claim 1, further comprising preprocessing the magnetic dataset for inversion.

5. The method of claim 2, wherein the second domain output model is correlated to the magnetic susceptibility model.

6. The method of claim 1, wherein the inversion of the magnetic dataset is based at least in part on a positivity constraint.

7. The method of claim 1, wherein the joint inversion of the magnetic dataset and the second dataset is based at least in part on a non-linear conjugate gradients algorithm.

8. The method of claim 1, wherein the second dataset comprises a datatype selected from the group consisting of refraction tomography data, reflection tomography data, gravity data, gradiometry data, magnetotelluric data, Controlled Source electromagnetic (CSEM) data, Time Domain electromagnetic data (TDEM), surface wave data and DC resistivity data.

9. The method of claim 1, further comprising jointly inverting a third dataset with the magnetic dataset and the second dataset.

10. A computing system, comprising:
at least one processor;
at least one memory; and
one or more programs stored in the at least one memory, wherein the one or more programs are configured to be executed by the one or more processors, the one or more programs including instructions for:
receiving a magnetic dataset that corresponds to a subterranean region;
receiving a second dataset that corresponds to the subterranean region; and
jointly inverting the magnetic dataset and the second dataset to generate a second domain model that corresponds to at least a part of the subterranean region, wherein the joint inversion of the magnetic dataset and the second dataset is based at least in part on a cross-gradients constraint.

11. The computing system of claim 10, further comprising the one or more programs including instructions for generating a magnetic susceptibility model that corresponds to at least the part of the subterranean region.

12. A method, comprising:
receiving three or more datasets corresponding to a subterranean region, wherein at least one of the datasets is a magnetic dataset; and
jointly inverting the three or more datasets to generate at least:
a first domain output model that corresponds to at least a first part of the subterranean region, and
a susceptibility model that corresponds to at least the first part of the subterranean region,
wherein the first domain output model is correlated to the susceptibility model.

13. The method of claim 12, wherein the correlation of the first domain output model to the susceptibility model is based at least in part on one or more effects of a link function.

14. The method of claim 12, wherein the inversion of the magnetic dataset is based at least in part on use of a positivity constraint.

15. The method of claim 12, wherein the inversion of the magnetic dataset is based at least in part on use of a non-linear algorithm.

16. The method of claim 12, wherein the joint inversion of the datasets is based at least in part on a cross-gradients constraint.

17. The method of claim 12, wherein at least one of the datasets corresponding to the subterranean region comprises a datatype selected from the group consisting of refraction tomography data, reflection tomography data, gravity data, gradiometry data, magnetotelluric data, Controlled Source electromagnetic (CSEM) data, Time Domain electromagnetic data (TDEM), surface wave data and DC resistivity data.

18. The method of claim 12, further comprising generating a cross domain dataset during the joint inversion.

19. The method of claim 12, further comprising generating one or more images of at least a first part of the subterranean region, wherein the generation of the one or more images is based at least in part on the first domain output model and the susceptibility model.

20. The method of claim 19, wherein the joint inversion includes generating a cross domain dataset, and wherein the generation of the one or more images is based at least in part on the cross domain dataset.
